(19) United States
(12) Patent Application Publication
(10) Pub. No.: US 2002/0031095 A1
(43) Pub. Date: Mar. 14, 2002

(54) Method for detecting flexible networking of modules with an arbitrary network topology and also for exchanging information between such modules

(76) Inventor: Peter Jaenicke, Erlangen (DE)

Correspondence Address: BAKER & BOTTS, 30 ROCKEFELLER PLAZA, NEW YORK, NY, 10112

(21) Appl. No.: 09/920,053

(22) Filed: Aug. 1, 2001

(30) Foreign Application Priority Data
Mar. 8, 2000 (DE) 100 379 69.9

(51) Int. Cl. H04L 12/28

(52) U.S. Cl. 370/255

(57) ABSTRACT

A method to detect the implemented network topology of modules which are flexibly networked by means of at least two bi-directional connection interfaces in a physical point-to-point connection in an arbitrary network topology, wherein messages which, instead of using a subscriber address, contain a description of the path through the network are used and the messages are suitably altered upon forwarding, in order to set up a description of the return path automatically.

### FIELD OF THE INVENTION

The invention relates to a method for detecting the implemented network topology having at least one master module and a plurality of slave modules which have at least two bi-directional connection interfaces, flexibly networked in a physical point-to-point connection in an arbitrary network topology, and each have a unique identification item.

### BACKGROUND OF THE INVENTION

For modem local networking strategies for electrical or electromechanical modules, e.g. for local drives, there is a need for designs which permit modules to be connected as flexibly as possible and which permit the simplest possible startup. The networking must therefore not be limited to a particular topology. The network topology possible for connecting modules should be a line, a ring, a star, a tree and any desired mixtures of the aforementioned topologies. Startup also needs to be possible from a central location without the need for adjustments on the individual bus subscribers.

Conventionally, networks require address assignment on each individual subscriber (switch setting or parameter setting), but this increases complexity and susceptibility to fault during startup. Otherwise, the network has only a restricted topology. This thus restricts the flexibility of networking.

It is therefore an object of the present invention to provide a method which a central location can use to detect the actually implemented topology and which permits communication with the individual modules. This should also work when a plurality of central modules, so-called master modules, are exploring the network topology at the same time.

### SUMMARY OF THE INVENTION

In accordance with the present invention, the aforesaid object is achieved by a method for detecting the implemented network topology with at least one master module and a plurality of slave modules which have at least two bi-directional connection interfaces, flexibly networked in a physical point-to-point connection in an arbitrary network topology, each of which have a unique identification data item, in that each master module gradually requests the identification data of each level of the slave modules connected to this master module by using said slave modules' connection interfaces to transmit messages containing information about which connection interface is to be used to forward the respective message. This information is altered upon forwarding of each message such that a description of the return path through the network is automatically set up. Each identification data item explored is returned to the master module via this return path using the respective message.

In a preferred embodiment of the method in accordance with the present invention, the method steps include:

carrying out a constant check at each connection interface of each module to determine connection to another module and reciprocal interchange of the respective identification data;

each master module sending a message to each module on the next highest level requesting that the respective configuration of the connection interfaces and the associated identification data be returned, the respective message containing information about which connection interface the modules on the preceding level are to use to forward the messages;

a description of the return path to the master module is automatically set up by virtue of each message being altered upon forwarding by the module on the preceding level by entering into the respective message which connection interface was used to receive the message; and

the preceding steps are recursively repeated for each next highest level of modules until all the modules have been identified.

Another preferred embodiment of the present invention prevents a detection problem where two or more parallel connections exist between a master module and a slave module, by virtue of the feature that each slave module receiving a request from a master module to return the message also returns, in addition to the respective configuration of the connection interfaces and the associated identification data, an information item via that connection interface which is used to transport back the message. This additional data item is not altered when forwarded by other modules. It is particularly advantageously if each identification data item comprises the module type, in particular the function thereof, and a unique serial number.

A further advantageous embodiment of the present invention, when forwarding an altered message by the module on the preceding level, the respective message is only received in full and is only forwarded when the prescribed transmitting connection interface is free.

A prerequisite of the invention is the use of a physical point-to-point connection. This is customary for fast data transfer (>100 Mbit/s) on account of the reflections which otherwise occur. For transmission via optical waveguides (LWL), a physical point-to-point connection is likewise provided.

A module in the network must therefore have two or more connection interfaces. Modules having one connection interface are also possible, but are then the end of a spur line, which is thus particularly appropriate for actuators and sensors, such as power sections and transmitters, where connection interface is able to be used to receive and send messages.

A plurality of connection interfaces are initially independent of one another. Each module has an identification data item (ID) which contains, by way of example, the module type (e.g. drive, power section, rotary transducer etc.) and a serial number.

The network is explored in a plurality of steps which are described below.

Each module constantly checks at each connection interface whether another module is connected, and if this is the case, they both exchange their IDs. This means that, after being turned on, each module has a configuration for its connection interfaces, said configuration storing the ID of the communication partner for each connection interface.

Using the same mechanism, a master module (that is to say a module which is provided, by virtue of presetting or parameter setting, to explore the network in an association of drives, e.g. a numerical controller) knows which connection interfaces have modules attached which, for their part, have further connection interfaces. This can be seen from the respective IDs. The master uses these connection interfaces to send messages requesting that the configuration of the connection interfaces and the IDs of the module be returned, as a result of which the modules on the first level are known.

When this has been done, the master module has an overview of the modules which can be reached not directly but rather only via another module (modules on the second level). These modules are now sent a message requesting that the ID and configuration be sent. The crucial factor in this case is that, for this purpose, the message contains information about which connection interface the modules on the first level are to use to forward the messages. The modules on the first level enter into the message which connection interface they have used to receive this message. In this way, the return path to the master is known for the response message. It is particularly advantageous in this context if the message is received in full and is only forwarded when the transmitting connection interface is free.

After interrogating all the other modules on the second level, the master module knows all the modules on the third level. This method is now applied recursively until all the modules in the network are known.

In another advantageous embodiment of the present invention, a different message type is used for messages sent by a master module than for messages which are to be received by a master module. And further, each message has a step counter for the maximum number of levels. The step counter is decremented for messages sent by a master module and is incremented for messages which are to be received by a master module, or vice versa. Further, the respective value of the step counter is used by a slave module to detect whether the desired level of slave modules has been reached. In addition, the respective value of the step counter is advantageously used by a master module to detect whether a response message has been directed to said master module.

Communication using the method in accordance with the present invention permits a further startup, e.g. by assignment of bus addresses, by parameter setting etc., by virtue of the feature that messages are used for detecting the network topology. While subsequent data interchange takes place between modules using subscriber addresses associated with the respective modules, with subscriber addresses being assigned during network detection to the detected module by a master module as part of a message.

It is particularly preferred for detection of the networking of the modules by the master module to be used for centrally starting up a numerically controlled industrial processing machine, in particular a machine tool or a robot, with a numerical controller as master module and a plurality of electrical drives as slave modules.

In addition, the novel method of the present invention can also be used for exchanging arbitrary information between modules which are flexibly networked in an arbitrary network topology in a physical point-to-point connection by virtue of the feature that each module can send and receive messages, and each message contains the information which is to be exchanged.

It is important to use messages which, instead of using a subscriber address, contain a description of the path through the network. Suitable alteration of the messages upon forwarding automatically sets up a description of the return path.

The novel method and opportunities for use described above provide, among other things, the following advantages over the known prior art:

no restrictions on the network topology are necessary;

incorrect connection of modules to the network is prevented, and even redundant and nonsensical connections do not disrupt the network;

no adjustments or parameter setting operations are required on the modules subscribing to the network, which simplifies startup, speeds it up and makes it less susceptible to fault;

when suitable bus physics are used—e.g. on the basis of the Universal Serial Bus (USB) standard—it is possible to connect or isolate modules to or from the network during operation; and

since no information is provided on the modules for the purpose of exploring the network, a plurality of masters can also examine the topology without being disrupted.

### DRAWINGS

Other particulars and details of the present invention are revealed with reference to the description which now follows of an advantageous exemplary embodiment and in conjunction with the drawings, where elements having the same functionality are characterized using the same reference symbols, and in which:

FIG. 1 shows a schematic illustration of a module;

FIG. 2 shows the basic message structure;

FIG. 3 shows interchange of the identification data between modules;

FIG. 4 shows data interchange between master module and first-level slave module;

FIG. 5 shows data interchange between master module and second-level slave module; and

FIG. 6 shows data interchange between master module and third-level slave module.

### DETAILED DESCRIPTION OF THE INVENTION

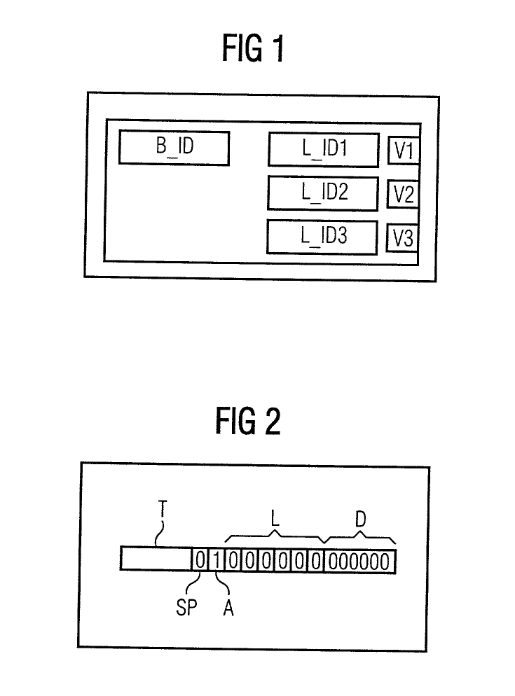

FIG. 1 shows the basic structure of a module. Each module, master module or slave module has a unique module identification data item B_ID. In addition, each module has at least two bi-directional connection interfaces, at least capable of half-duplex, provided that the modules are not end subscribers on a spur line, such as sensors or actuators. In FIG. 1, three connection interfaces V1, V2, V3 are provided for which there are respective memory locations for holding the connection partner identification data item L_ID1, L_ID2, L_ID3, that is to say the module ID of the module connected to the respective interface.

FIG. 2 shows one possible structure of the message for exchange between the modules. The message comprises a list of data which contains the message type, a step counter, the number of maximum steps, a further list of the connection interfaces and also optional data for holding information which is to be transmitted. The order is arbitrary, but must be handled on a standard basis in the form of a protocol.

In the exemplary embodiment, the message type T, either request mode (e.g. value “0”) or response mode (e.g. value “1”), is at the start, followed by the step counter SP and the number A of maximum steps, which is connected to the number of levels to be examined within the network. This is followed by a list L containing the possible connection interfaces and also an optional data area D.

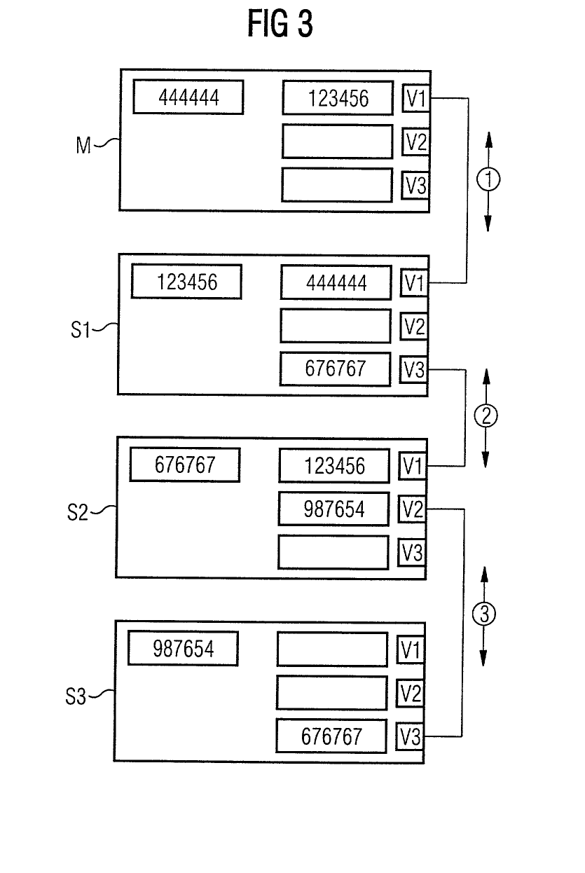

FIG. 3 shows the first method step, which comprises the interchange of the module identification data B_ID of the individual modules in the network. The network shown comprises a master module M (ID=444444) and three slave modules S1 (ID=123456), S2 (ID=676767) and S3 (ID=987654), each having the structure described in FIG. 1.

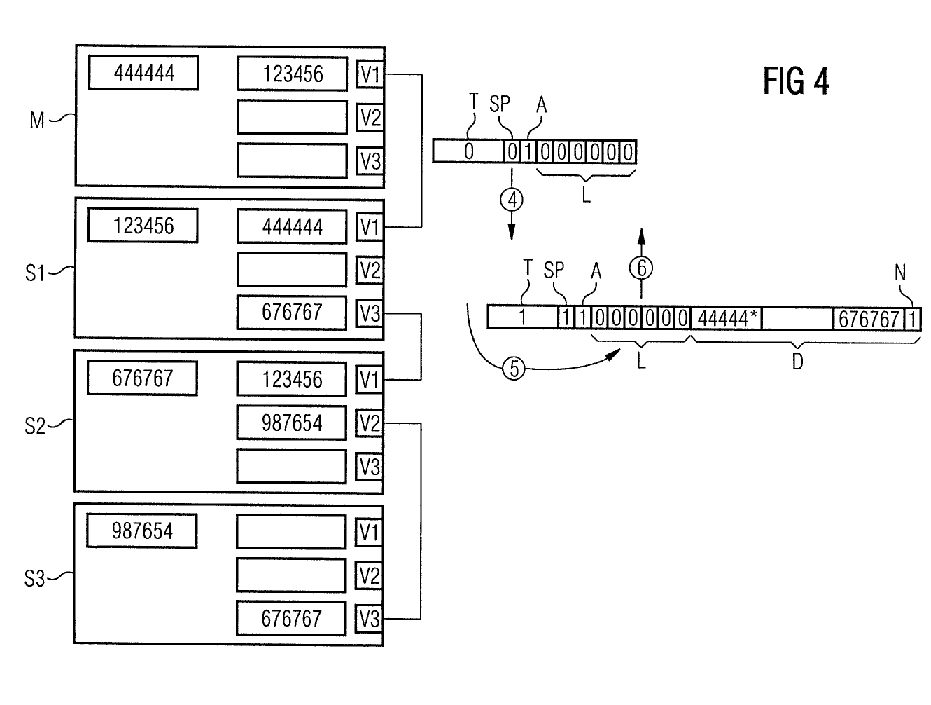

The master module M and the slave module S1 are connected to one another by means of their respective connection interfaces V1. The slave module S2 is connected by means of its connection interface V1 to the interface V3 of the slave module S1. The slave module S3, in turn, is connected by means of its connection interface V3 to the interface V2 of slave module S2. This basic structure of the network also forms the basis of the further illustrations shown in FIG. 4 to FIG. 6.

In method step 1, the master module M and the slave module S1 exchange their respective module IDs, so that the module ID of slave module S1 is known in the memory location associated with interface V1 of the master module, and vice versa. In step 2, the same happens between the slave modules S1 and S2, and in step 3 for the slave modules S2 and S3. The result of the first three method steps 1 to 3 is that the master module M knows the subscribers on its connection interfaces.

FIG. 4 shows the data interchange between the master module and the modules on the first level, in this case the slave module S1. In this context, in addition to the modules M and S1 involved, the messages associated therewith and with the method steps 4 to 6 explained below are shown.

The transmitted message has the structure shown in FIG. 2. The message type T is ‘request’ or “0”, the step counter SP is at “0”, the number A of maximum steps is “1”, and the list L containing the connection interfaces is arbitrary in this message (in the example shown, all positions at zero).

In a method step 4, this message is sent to the slave module S1. The information ‘step counter SP=0’ shows the slave module S1 that it is the destination of the message.

The slave module S1 then responds in method step 5 with the configuration of its connection interfaces by appending this information and the number N of the connection interface used to return the message—in this case “1”—as data D to the message, and changing the message type T to ‘response’ or “1”. The step counter SP is incremented to SP=1, and the message is sent again via the receiving interface—in this case V1.

In a further method step 6, the master module M recognizes from the match between the step counter SP and the number A of maximum steps (both have the value “1”) that it is the destination of the response message. The appended data D thus serve to inform the master module M of the subscribers on the slave module S1.

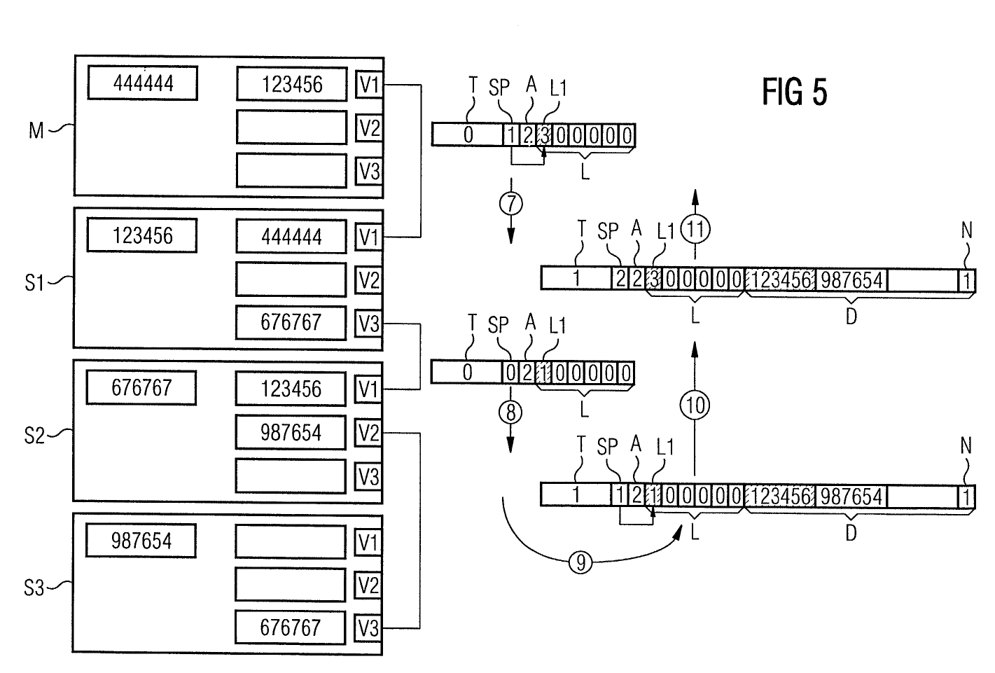

FIG. 5 shows the data interchange between the master module and the modules on the second level, in this case the slave module S2. In this context, in addition to the modules M, S1 and S2, the messages associated with the method steps 7 to 11 explained below are shown.

The transmitted message again has the structure shown in FIG. 2. The message type T is ‘request’ or “0”, the step counter SP is at “1”, the number A of maximum steps is “2”, and the list L containing the connection interfaces contains the value “3” in this message only at the first list location L1. The other positions are arbitrary (in the example shown, all positions at zero). The value “1” of the step counter SP is a reference (pointer) to the list location L1.

In a method step 7, the message is sent to the slave module S1. The information ‘step counter SP=1’ shows the slave module S1 that it is not the destination of the message, and this slave module forwards the message in method step 8 via the connection interface noted in list location L1—in this case to the slave module S2 via the connection interface V3, which corresponds to the value L1=3. In addition, the number of the receiving interface—in this case “1” on account of connection interface V1 of slave module S2—is previously entered at list location L1, and the step counter SP is decremented to “0” on account of the message type 0=“request”.

The slave module S2 then responds in method step 9 with the configuration of its connection interfaces by appending this information and also the number N of the connection interface used to return the message—in this case likewise “1”—as data D to the message, and changing the message type T to ‘response’ or “1”. The step counter SP is incremented to SP=1, and the message is sent again via the receiving interface—in this case V1.

In the next method step 10, the slave module S1 connected to this interface detects from the step counter value SP=1 that it is not the addressee and forwards the message via the connection interface noted at list location L1 of the message—in this case, this is the value “1”, that is to say connection interface V1. The receiving interface—in this case, value=3 for connection interface V3—is previously entered at the list location L1, and the step counter SP is incremented to SP=2 on account of the message type 1=“response”.

In method step 11, the master module M detects from the match between step counter SP and the number A of maximum steps (both have the value “2”) that it is the destination of the response message. The appended data D thus also serve to inform the master module M of the subscribers on the slave module S2.

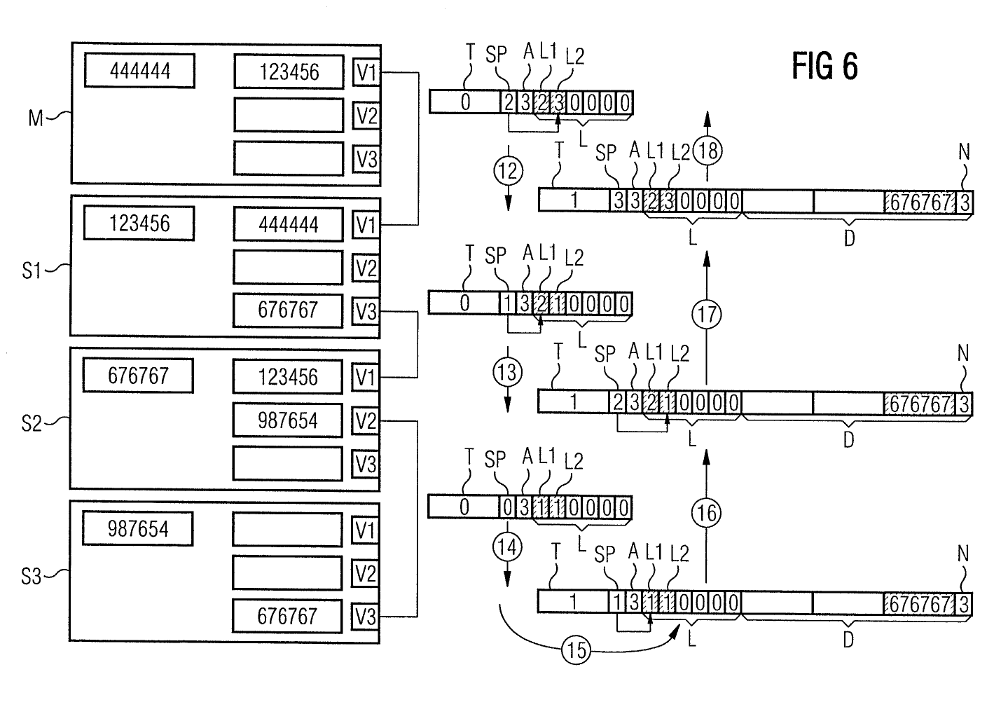

FIG. 6 shows the data interchange between the master module and the modules on the third level, in this case the slave module S3. In this context, in addition to the modules M, S1 and S2, the messages associated with the method steps 12 to 18 explained below are shown.

The transmitted message again has the structure shown in FIG. 2. The message type T is ‘request’ or “0”, the step counter SP is at “2”, the number A of maximum steps is “3”, and the list L containing the connection interfaces contains the value “2” and the value “3”, in this message at the two first list locations L1 and L2, respectively. The other positions are arbitrary (in the example shown, all positions at zero). The value “2” of the step counter SP is a reference (pointer) to the list location L2.

In method step 12, the message is sent to the slave module S1. The information ‘step counter SP=2’shows the slave module S1 that it is not the destination of the message, and this slave module forwards the message in method step 13 via the connection interface noted at the list location L2—in this case, to the slave module S2 via the connection interface V3, which corresponds to the value L2=3.

In addition, the number of the receiving interface—in this case “1” on account of connection interface V1 of slave module S2—is previously entered at list location L2, and the step counter SP is decremented to “1” on account of the message type 0=“request”.

The information ‘step counter SP=1’ shows the slave module S2 that it is not the destination of the message, and this slave module forwards the message in method step 14 via the connection interface noted at list location L1—in this case, to the slave module S3 via the connection interface V2, which corresponds to the value L1=2.

In addition, the number of the receiving interface—in this case “1” on account of connection interface V1 of slave module S2—is previously entered at list location L1, and the step counter SP is decremented to “0” on account of the message type 0=“request”.

The slave module S3 then responds in method step 15 with the configuration of its connection interfaces by appending this information and also the number N of the connection interface used to return the message—in this case “3”—as data D to the message, and changing the message type T to ‘response’ or “1”. The step counter SP is incremented to SP=1, and the message is sent again via the receiving interface—in this case V3.

In method step 16, the slave module S2 connected to this interface detects from the step counter value SP=1 that it is not the addressee, and forwards the message via the connection interface noted at list location L1 of the message—in this case, this is the value “1”, that is to say connection interface V1. The receiving interface—in this case, value=2 for connection interface V2—is previously entered at the list location L1, and the step counter SP is incremented to SP=2 on account of the message type 1=“response”.

In method step 17, the slave module S1 connected to this interface detects from the step counter value SP=2 that it is not the addressee, and forwards the message via the connection interface noted at list location L2 of the message—in this case, this is the value “1”, that is to say connection interface V1. The receiving interface—in this case, value=3 for connection interface V3—is previously entered at the list location L2, and the step counter SP is incremented to SP=3 on account of the message type 1=“response”.

In method step 18, the master module M detects from the match between step counter SP and the number A of maximum steps (both have the value “3”) that it is the destination of the response message. The appended data D also serve to inform the master module M of the subscribers on the slave module S3, and hence of all the slave modules in the network.

Should a fourth level and other levels of modules also exist in the network, the method explained above would be recursively continued until all the levels with the associated modules have been explored and are thus known.

I claim:

1. A method for detecting an implemented network topology with at least one master module and a plurality of slave modules levels said slave modules having at least two bi-directional connection interfaces, said modules being flexibly networked in a physical point-to-point connection in an arbitrary network topology module and each having a unique identification data item, comprising said at least one master module gradually requesting the identification data of each level of the slave modules connected to this master module by using said slave modules' connection interfaces to transmit messages containing information about which connection interface is to be used to forward the respective message, said information being altered upon forwarding of each message such that a description of a return path through the network is automatically set up, each identification data item explored being returned to the master module via this return path using the respective message.

2. The method according to claim 1, further comprising the steps of carrying out a constant check at each connection interface of each module to determine connection to another module and reciprocal interchange of the respective identification data; each master module sending a message to each module on a next highest level requesting that the connection interfaces configuration and associated identification data be returned, the respective message containing information about which connection interface the modules on the preceding level are to use to forward the messages; setting up automatically a description of the return path to the master module by virtue of each message being altered upon forwarding by the module on a preceding level by entering into the respective message which connection interface was used to receive the message; and repeating the preceding steps recursively for each next highest level of modules until all the modules have been identified.

3. The method according to claim 1 or 2, wherein each slave module receives a request from a master module to return the message additionally returns a data item via the connection interface which is used to transport back the message, said additional data item not being altered when forwarded by other modules.

4. The method according to claim 1, wherein each identification data item comprises the module type and a unique serial number.

5. The method according to claim 1, wherein to alter a message when forwarded by the module on the preceding level, the respective message is only received in full and is only forwarded when the prescribed transmitting connection interface is free.

6. The method according to claim 1, wherein a different message type is used for messages sent by a master module than for messages which are to be received by a master module.

7. The method according to claim 1, wherein each message has a step counter for the maximum number of levels, which step counter is decremented for messages sent by a master module and is incremented for messages which are to be received by a master module, or vice versa.

8. The method according to claim 7, wherein the respective value of the step counter is used by a slave module to detect whether the desired level of slave modules has been reached.

9. The method according to claim 7 or 8, wherein the respective value of the step counter is used by a master module to detect whether a response message has been directed to said master module.

10. The method according to claim 1, wherein messages are used for detecting the network topology, while subsequent data interchange takes place between modules using subscriber addresses associated with the respective modules, with subscriber addresses being assigned during network detection to the detected module by a master module as part of a message.

11. A method for centrally starting up a numerically controlled industrial processing machine having a numerical controller as master module and a plurality of electrical drives as slave modules, the networking of the modules being detected by the master module in accordance with the method of claim 1.

12. The method according to claim 1, wherein modules have only one connection interface which can be used to receive and send messages which are located on a spurline end.

13. The use of the method according to claim 1 for exchanging arbitrary information between modules which are flexibly networked in an arbitrary network topology in a physical point-to-point connection, wherein each module can send and receive messages, and each message contains the information which is to be exchanged.
